(19) United States
(12) Patent Application Publication
(10) Pub. No.: US 2015/0222648 A1
(43) Pub. Date: Aug. 6, 2015

(54) APPARATUS FOR ANALYZING THE ATTACK FEATURE DNA AND METHOD THEREOF

(71) Applicant: Electronics and Telecommunications Research Institute, Daejeon (KR)

(72) Inventors: Jong-Hyun KIM, Daejeon (KR); Ik-Kyun KIM, Daejeon (KR)

(21) Appl. No.: 14/596,188

(22) Filed: Jan. 13, 2015

(30) Foreign Application Priority Data
Feb. 3, 2014 (KR) 10-2014-0012271

(51) Int. Cl. H04L 29/06; G06F 21/56

(52) U.S. Cl. CPC H04L 63/1416; G06F 21/561; H04L 63/1458; H04L 2463/142

(57) ABSTRACT

The present invention provides an attack feature DNA generator comprising: an information processing unit collecting event information from a network environment; a factor extracting unit extracting normal factors and attack feature factors from the event information; a DNA generating unit analyzing correlation of the attack feature factor to the normal factor and generating an attack feature DNA which shows the correlation analysis result in a DNA structure; and a storing unit in which the event information and the attack feature DNA are stored. The present invention allows intuitively recognizing an ongoing attack type by comparing collected cyber-attack feature factors with cyber-attack feature DNAs.

### CROSS REFERENCE TO RELATED APPLICATION

This application claims the benefit of Korean Patent Application No. 10-2014-0012271, filed on Feb. 3, 2014, entitled “Apparatus for analyzing the attack feature DNA and method thereof”, which is hereby incorporated by reference in its entirety into this application.

### BACKGROUND OF THE INVENTION

1. Technical Field

The present invention relates to a technology for analyzing an attack feature DNA by using attack feature DNAs and more particularly, to an apparatus for analyzing an attack feature DNA which extracts unique attack feature factors from collected event information and represents correlation between the attack feature factors in a DNA structure type.

2. Description of the Related Art

In general, internet is an open network that is configured to allow everyone the freedom to information transmissions by applying a common protocol called TCP/IP on an opponent's computer anyone want to connect anywhere around the world. Importance of the internet has been rapidly increasing as a strategic tool for improving efficiency and productivity throughout the existing industries as its use is rapidly increasing all over the world including domestic use.

On the other hand, there are attacks to steal or spy specific or desired information by attacking the target computers connected to the internet by using a malicious program as a factor that may disrupt communication environment via the internet. The malicious program is a general term of the executable code created for malicious purposes and is also called as malware (malicious software) or a malicious code. It can be classified as virus, worm virus, Trojan horse and the like according to the presence or absence of infection target and self-replication.

Conventional prevention technologies of such malicious programs detect and block the signature for attacks or filter traffics in the network to block malicious traffics. Signature is a collected virus sample and can be also described as evidence of virus. The signature is used to provide anti-virus software. The signature-based detection is a technology generating a signature to detect a malicious code by analyzing features of pre-collected malicious codes, scanning malware based on the signature, and performing malicious program processing when any malicious program is detected.

However, since thousands, tens of thousands of malicious codes are generated per day, the gap between the number of new malicious codes made by attackers and the number of signatures treated by security companies cannot be easily narrowed down, but it is actually increasing gradually. Since new malicious codes which obfuscate vaccines are produced at a faster rate by making variant malicious codes by constantly changing the internal structure of malicious codes such as source codes, functions and the like, detecting and preventing cyber-attacks is becoming more difficult.

Therefore, it is essential to intuitively understand security situation occurring within an organization by extracting and analyzing attack feature factors from multiple sources information and effectively visualizing the analyzed situation in order to recognize in advance and analyze integrally cyber terror-typed attacks targeting the information system of a specific industry.

### PRIOR ART

KR Patent No. 10-0942456 (title: Method for detecting and protecting DDoS attack by using cloud computing and server thereof)

### SUMMARY OF THE INVENTION

An object of the invention is to provide an apparatus for analyzing an attack feature DNA which represents correlation between attack feature factors extracted from event information, which is collected from a single network environment, in a DNA structure type, and a method thereof.

Another object of the present invention is to provide an apparatus for analyzing an attack feature DNA which generates an attack feature DNA from collected event information and then compares and analyzes the result with past attack feature DNAs by attacking patterns, and a method thereof.

In an embodiment of the present invention, there is provided an attack feature DNA generator comprising: an information processing unit collecting event information from a network environment; a factor extracting unit extracting normal factors and attack feature factors from the event information; a DNA generating unit analyzing correlation of the attack feature factor to the normal factor and generating an attack feature DNA which shows the correlation analysis result in a DNA structure; and a storing unit in which the event information and the attack feature DNA are stored.

Particularly, the network environment is a single network.

Particularly, the attack feature DNA is classified and stored by attacking patterns in the storing unit.

Particularly, the attack feature DNA generator further comprises a DNA visualizing unit visualizing the attack feature DNA.

Particularly, the attack feature DNA generator further comprises a displaying unit displaying the visualized attack feature DNA.

In another embodiment of the present invention, there is provided an attack feature DNA analysis device comprising; an information processing unit collecting event information from a network environment; a factor extracting unit extracting normal factors and attack feature factors from the event information; a DNA generating unit analyzing correlation of the attack feature factor to the normal factor and generating an attack feature DNA which shows the correlation analysis result in a DNA structure; a storing unit in which past attack feature DNAs classified by attacking patterns are stored; and an attack similarity analyzing unit analyzing similarity by comparing the attack feature DNA with the past attack feature DNAs stored in the storing unit.

Particularly, the attack similarity analyzing unit represents similarity between the attack feature DNA and the attack feature DNA classified by attacking patterns in a numerical value.

In still another embodiment of the present invention, there is provided a method for generating attack feature DNA, comprising: collecting event information from a network environment; extracting normal factors and attack feature factors from the event information; analyzing correlation of the attack feature factor to the normal factor and generating an attack feature DNA which shows the correlation analysis result in a DNA structure; and storing the event information and the attack feature DNA.

In still another embodiment of the present invention, there is provided a method for analyzing attack feature DNA, comprising: storing past attack feature DNAs classified by attacking patterns; collecting event information from a network environment; extracting normal factors and attack feature factors from the event information; analyzing correlation of the attack feature factor to the normal factor and generating an attack feature DNA which shows the correlation analysis result in a DNA structure; analyzing similarity by comparing the attack feature DNA with the past attack feature DNAs classified by attacking patterns and stored in the storing unit.

The present invention allows efficient detection of attack patterns by establishing and managing attack feature DNA profiles against cyber-attacks occurred in the past by using big data platform.

In addition, the present invention allows intuitively recognizing an ongoing attack type by comparing collected cyber-attack feature factors with cyber-attack feature DNAs.

### BRIEF DESCRIPTION OF DRAWINGS

FIG. 1 is a configuration view illustrating an attack feature DNA generator according to an embodiment of the present invention.

FIG. 2 is a configuration view illustrating an attack feature DNA analysis device according to an embodiment of the present invention.

FIG. 3 is an exemplary view illustrating a displaying unit according to an embodiment of the present invention which displays an attack feature DNA.

FIG. 4 is an exemplary view illustrating a displaying unit according to an embodiment of the present invention which displays an attack similarity analysis.

FIG. 5 is flowchart illustrating an attack feature DNA generator according to an embodiment of the present invention.

FIG. 6 is flowchart illustrating an attack feature DNA analysis device according to an embodiment of the present invention.

FIG. 7 is a configuration view illustrating a computer system according to an embodiment of the present invention.

### DESCRIPTION OF THE EXEMPLARY EMBODIMENTS

The above and other objects, features and advantages of the present invention will become more apparent to those of ordinary skill in the art by describing in detail exemplary embodiments thereof with reference to the accompanying drawings.

The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application. The terms used in the description are intended to describe certain embodiments only, and shall by no means restrict the present invention. In addition, throughout the description of the present invention, when describing a certain technology is determined to evade the point of the present invention, the pertinent detailed description will be omitted. In descriptions of components of the invention, the same reference numeral may be assigned to the same component regardless of the drawings in order to facilitate a thorough understanding.

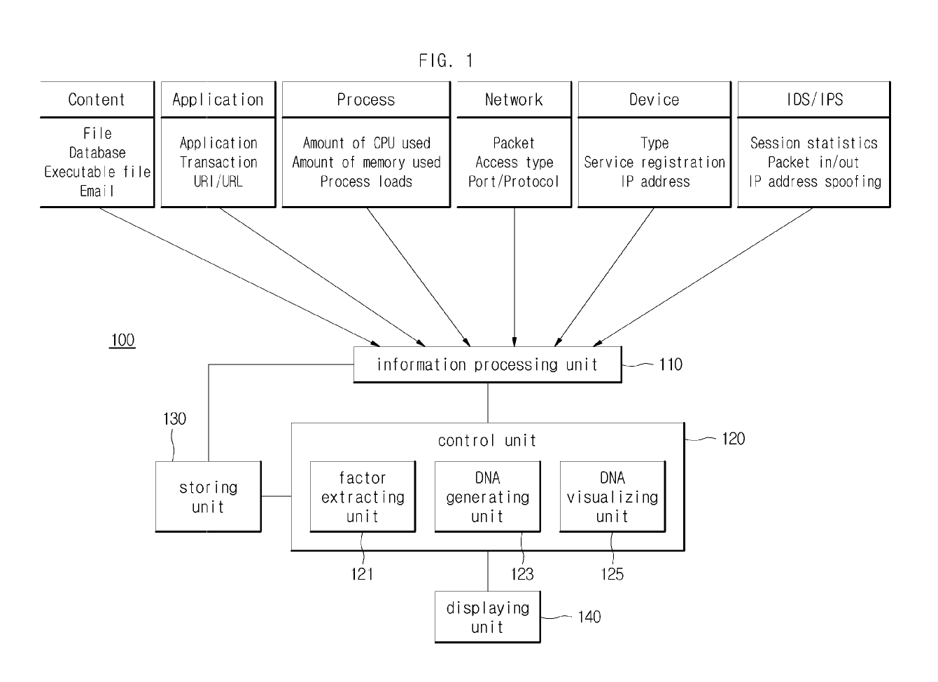

FIG. 1 is a configuration view illustrating an attack feature DNA generator according to an embodiment of the present invention.

Referring to FIG. 1, an attack feature DNA generator 100 comprises an information processing unit 110, a control unit 120, a storing unit 130 and a displaying unit 140. The control unit 120 comprises a factor extracting unit 121, a DNA generating unit 123 and a DNA visualizing unit 125.

The information processing unit 110 collects event information from a network environment. The information processing unit 110 transmits the collected event information to the factor extracting unit 121 when a transmission signal is received from the factor extracting unit 121. The information processing unit 110 transmits the collected event information to the storing unit 130 to store.

The event information may be information about network components such as network, network equipment, user PC and server, etc. The event information may be information from various sources. The event information may be formed as log information. The event information may include contents information, application information, process information, network information, device information, IDS/IPS information and the like. The contents information includes information about files, databases, executable files, emails and the like. The application information includes information about transactions, URIs (Uniform Resource Identifier), URLs (Uniform Resource Locator), URNs (Uniform Resource Name) and the like. The process information includes information about amount of CPU used, amount of memory used, process loads and the like. The network information includes information about packets, access types, ports, protocols and the like. The device information includes information about types, IP (internet protocol) addresses and the like. The IDS (Intrusion Detecting System)/IPS (Intrusion Preventing System) information includes information about session statistics, packet In/Out, if there is any IP address spoofing and the like.

The event information includes attack information. The attack information includes information about malicious programs. An attacker who attacks network causes damages to network elements through attack information including the malicious program.

The event information is used to extract factors by the factor extracting unit 121. Attack information of the event information is extracted as an attack feature factor 320 and the even information which is not the attack information is extracted as a normal factor 310.

The factor extracting unit 121 extracts factors from the event information. The factor extracting unit 121 receives the event information to be factor-extracted from the information processing unit 110 when the event information transmission signal is transmitted to the information processing unit 110. The factor extracting unit 121 extracts attack feature factors 320 from attack information in the event information and normal factors 310 from the event information which is not the attack information. The factor extracting unit 121 extracts factors by using various analysis algorithms to detect attacks from the event information.

The factor is a basic object which consists a file DNA (hereinafter referred to as “DNA”) and is also called as an atomic key. The factor includes a normal factor 310 and an attack feature factor 320. The attack feature factor 320 is formed from attack information included in the event information and the normal factor 310 is formed from the event information which is not the attack information. All factors including the normal factor 310 and the attack feature factor 320 can be combined with each other to correspond to their relevance and combined factors generate a DNA.

The DNA generating unit 123 analyzes correlation between factors and represents the correlation analysis result in a DNA structure. The DNA generating unit 123 generates a normal DNA 313 by combining normal factors 310 from the event information collected by types from network elements such as network, network equipment, user PC, server and the like to correspond to the relevance of the normal factors 310.

The DNA generating unit 123 generates an attack feature DNA 323 based on the normal factor 310 and the attack feature factor 320. The DNA generating unit 123 generates an attack feature DNA 323 by combining the attack feature factors 320 for attack information with the normal factors 310 to correspond to the correlation of the normal factors 310 and the attack feature factors 320. The DNA generating unit 123 generates an attack feature DNA 323 by attaching and combining the attack feature factors 320 to the normal DNA 313. The DNA generating unit 123 stores the generated attack feature DNA 323 in the storing unit 130.

The DNA visualizing unit 125 visualizes the attack feature DNA 323. The DNA visualizing unit 125 represents the normal factor 310, the attack feature factor 320, the normal DNA 313 and the attack feature DNA 323, etc. visually to display in the displaying unit 140. The DNA visualizing unit 125 generates a normal factor list 311 of the normal factors 310 and an attack feature factor list 321 of the attack feature factors 320. The DNA visualizing unit 125 visualizes the normal DNA 313 generated by the DNA generating unit 123 and visualizes the attack feature DNA 323 generated by the DNA generating unit 123 by representing the attack feature factors 320 to a corresponding DNA part of the normal DNA 313.

The DNA visualizing unit 125 can visualize the normal factor 310, the attack feature factor 320, the normal DNA 313 and the attack feature DNA 323, etc. in a 2D or 3D. Here, a visualization engine corresponding to an appropriate format is used. The DNA visualizing unit 125 rotates the DNA at a variety of angles or enlarges or reduces the DNA to detect if any attack is caused in a network. The event information and the attack feature DNA 323 are stored in the storing unit 130. The DNA generating unit 123 stores the attack feature DNA 323 in the storing unit 130. The stored attack feature DNA 323 is classified by attacking patterns and then stored. The stored attack feature DNA 323 is then considered as a past attack feature DNA (401, 403, 405, 407) to be compared with an ongoing attack feature DNA 323 as an atomic key.

The displaying unit 140 displays the visualized normal factor 310, attack feature factor 320, normal DNA 313 and attack feature DNA 323, etc. on the screen.

A network, to which the attack feature DNA generator 100 is connected, may be a sub-network which is not connected to any external network as a single network. For example, the single network may be any company's or organization's own network. The attack feature DNA generator 100 may be operated in an environment such as cloud computing network to which external networks are connected.

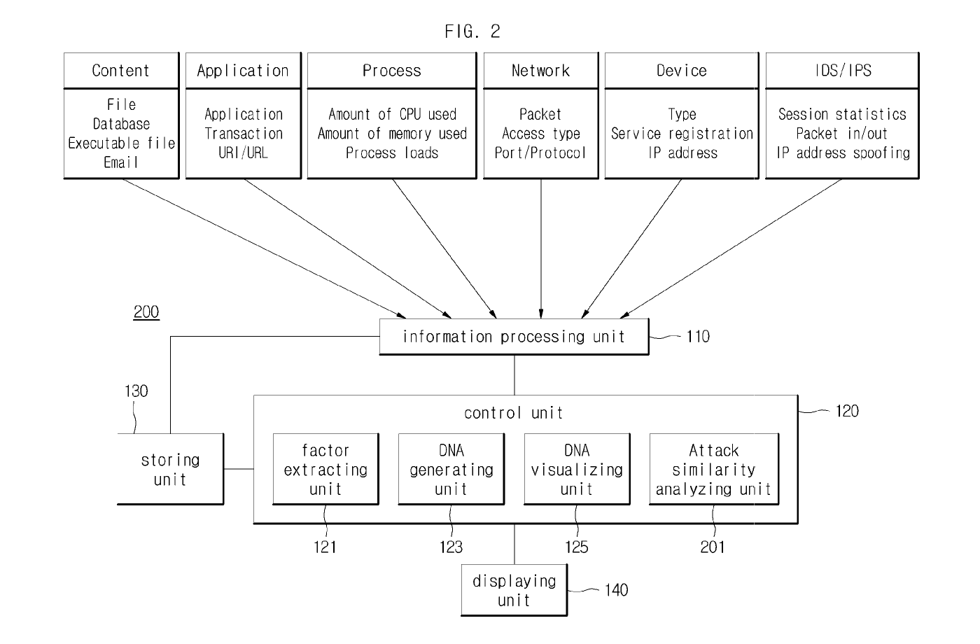

FIG. 2 is a configuration view illustrating an attack feature DNA analysis device according to an embodiment of the present invention.

Referring to FIG. 2, an attack feature DNA analysis device 200 further comprises an attack similarity analyzing unit 201 in addition to the information processing unit 110, the control unit 120, the storing unit 130 and the displaying unit 140.

The factor extracting unit 121 extracts an attack feature factor 320 from attack information when the attack information is included in event information. Whenever an attack is caused and attack information is included in the event information, the factor extracting unit 121 extracts the attack information from the event information and generates an attack feature factor 320. The attack feature factor 320 is then an atomic key forming past attack feature DNAs (401, 403, 405, 407).

The DNA generating unit 123 analyzes correlation between the attack feature factor 320 to the normal factor 310 and generates past attack feature DNAs (401, 403, 405, 407) represented in DNA structure for the correlation analysis result. The DNA generating unit 123 generates past attack feature DNAs (401, 403, 405, 407) by combining the attack feature factors 320 of attack information collected by types to correspond to the correlation between the attack feature factor 320 and the normal factor 310. The past attack feature DNAs (401, 403, 405, 407) are generated in the same manner as the normal DNA 313 and the attack feature DNA 323 are generated. Then only attack information included in the event information from the past to the latest is extracted and classified by attacking patterns to provide DNA data. The past attack feature DNAs (401, 403, 405, 407) are DNAs which record types of past attacks. The DNA generating unit 123 stores the generated past attack feature DNAs (401, 403, 405, 407) in the storing unit 130.

The attack similarity analyzing unit 201 compares the attack feature DNA 323 with the past attack feature DNAs (401, 403, 405, 407) stored in the storing unit 130 to analyze similarity. The attack similarity analyzing unit 201 matches the DNA structure of the attack feature DNA 323 to those of the past attack feature DNAs (401, 403, 405, 407) to determine the similarity of the attack feature DNA 323 to a particular past attack feature DNA (401, 403, 405, 407).

The attack similarity analyzing unit 201 represents the attack similarity in a numerical value. The attack similarity analyzing unit 201 may exhibit the value of the attack similarity in a ratio or yes/no or the like.

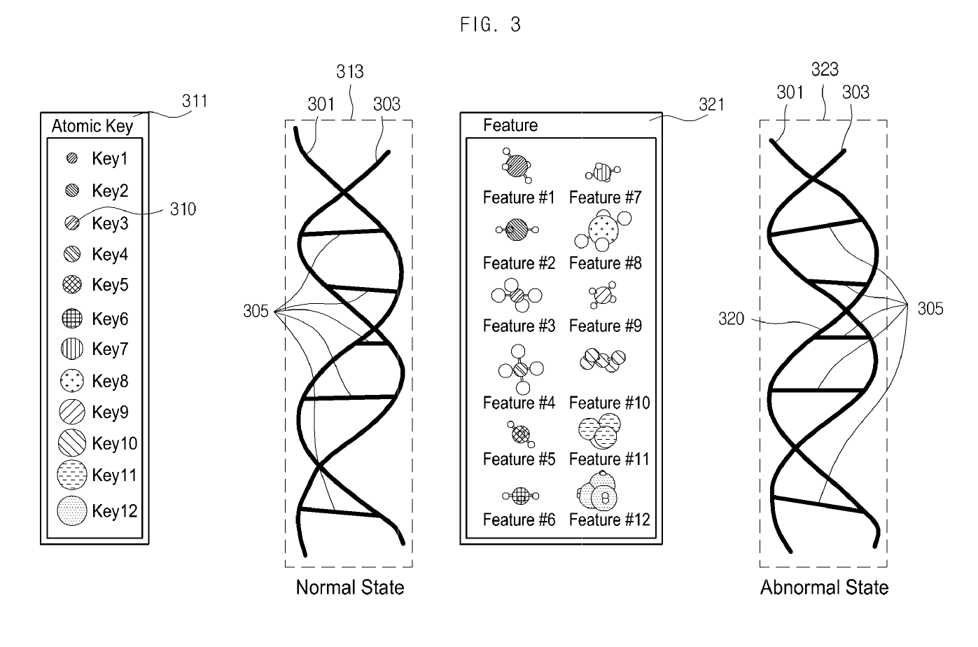

FIG. 3 is an exemplary view illustrating a displaying unit according to an embodiment of the present invention which displays an attack feature DNA.

Referring to FIG. 3, an example of the normal DNA 313 and the attack feature DNA 323 displayed in the displaying unit 140 is illustrated. The displaying unit 140 displays the normal factors visualized by the DNA visualizing unit 125, the normal factor list 311 of the normal factors, the normal DNA 313, the attack feature factors, the attack feature factor list 321 of the attack feature factors, and the attack feature DNA 323.

The displaying unit 140 displays the normal DNA 313 in the normal state region on the left and the attack feature DNA 323 in the abnormal state region on the right. However, display is not limited thereto but can be displayed in a variety of ways.

The DNA including the normal DNA 313 and the attack feature DNA 323 includes 3 parts of a left DNA strand 301, a right DNA strand 303 and a central DNA strand 305. Each of the DNA strands (301, 303, 305) is composed with factors having different information.

Here, each of the DNA strands in FIG. 3 is displayed by lines, but the displaying unit 140 may display each of the DNA strands to connect at least one of the normal factors included in the normal factor list 311 and the attack feature factors included in the attack feature factor list 321.

Particularly, the left DNA strand 301 is composed with factors of information relating to host and server, the right DNA strand 303 is relating to network, and the central DNA strand 305 is relating to correlation between the information of the host and server and the information of network. Information included in the DNA strands (301, 303, 305) is not limited thereto but may be other information.

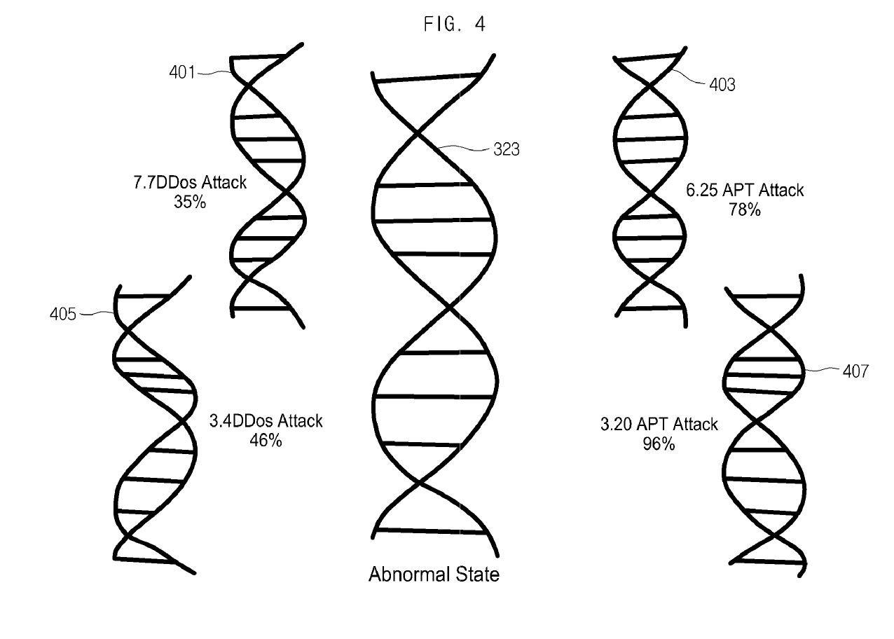

A user can compare DNAs in both states and detect where the attack feature factor 320 is located and further intuitively recognize an attacking pattern. FIG. 4 is an exemplary view illustrating a displaying unit according to an embodiment of the present invention which displays an attack similarity analysis.

Referring to FIG. 4, an example of past attack feature DNAs (401, 403, 405, 407) displayed in the displaying unit 140 is illustrated. The displaying unit 140 displays the attack feature DNA 323 visualized by the DNA visualizing unit 125 and the past attack feature DNAs (401, 403, 405, 407). Here, strands of the past attack feature DNAs (401, 403, 405, 407) and the attack feature DNA 323 are displayed by lines. However, the displaying unit 140 may display strands of the past attack feature DNAs (401, 403, 405, 407) and the attack feature DNA 323 to connect at least one of the normal factors included in the normal factor list 311 and the attack feature factors included in the the attack feature factor list 321.

The displaying unit 140 displays the attack feature DNA 323 at the abnormal state region which is at the center and the past attack feature DNAs (401, 403, 405, 407) around the attack feature DNA 323. However, display is not limited thereto but can be displayed in a variety of ways.

The DNA generating unit 123 generates past attack feature DNAs (401, 403, 405, 407). The DNA visualizing unit 125 visualizes the past attack feature DNAs (401, 403, 405, 407) so that a user can see them. The displaying unit 140 displays the past attack feature DNAs (401, 403, 405, 407) by attacking patterns on the screen.

The attack similarity analyzing unit 201 represents the attack similarity in a numerical value. The attack similarity analyzing unit 201 may exhibit the value of the attack similarity in a ratio or yes/no or the like.

In drawings of the present invention, the past attack feature DNA 401 is a DNA of DDoS attack on Jul. 7, 2009 and the attack similarity is 35%. The past attack feature DNA 403 is a DNA of APT attack on Jun. 25, 2013 and the attack similarity is 78%. The past attack feature DNA 405 is a DNA of DDoS attack on Mar. 4, 2011 and the attack similarity is 46%. The past attack feature DNA 407 is a DNA of APT attack on Mar. 20, 2013 and the attack similarity is 96%. A user can recognize that the most similar attack to the currently detected attack feature DNA 323 is the APT attack of Mar. 20, 2013, against which the similarity is 96%, among 4 past attack feature DNAs (401, 403, 405, 407). The user can thus analyze the currently detected attack through the past attack feature DNA 407 and prepare countermeasure thereto.

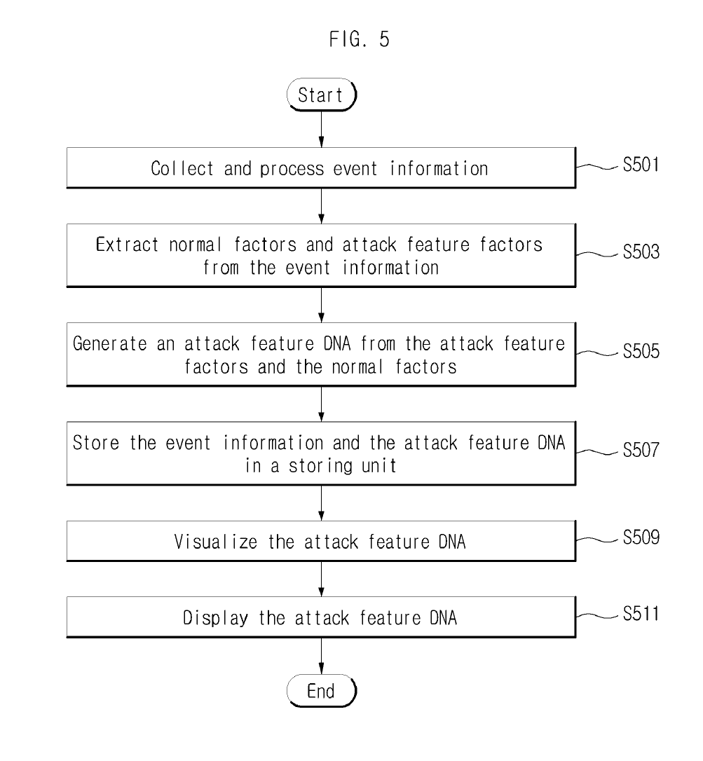

FIG. 5 is flowchart illustrating an attack feature DNA generator according to an embodiment of the present invention.

Referring to FIG. 5, in S501, information processing unit 110 collects event information from network elements such as network, network equipment, user PC, server and the like and stores it.

In S503, the factor extracting unit 121 extracts normal factors 310 and attack feature factors 320 from the event information.

In S505, the DNA generating unit 123 analyzes correlation of the attack feature factor 320 with the normal factor 310 and generates the attack feature DNA 323 which represents the correlation analysis result in a DNA structure by combining the attack feature factor 320 with the normal factor 310.

In S507, the DNA generating unit 123 stores the event information and the attack feature DNA 323 in the storing unit 130. Here, the DNA generating unit 123 classifies the attack feature DNA 323 by attacking patterns and then stores the result.

In S509, the DNA visualizing unit 125 visualizes the normal factor 310, the normal DNA 313, the attack feature factor 320, the attack feature DNA 323 and the past attack feature DNAs (401, 403, 405, 407).

In S511, the displaying unit 150 displays the visualized normal factor 310, normal DNA 313, attack feature factor 320, attack feature DNA 323 and past attack feature DNAs (401, 403, 405, 407).

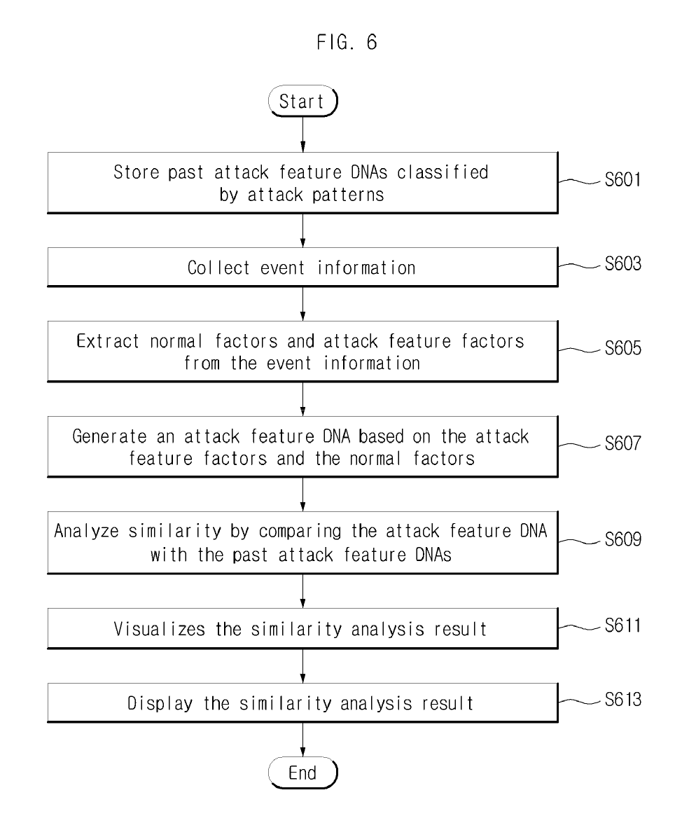

FIG. 6 is flowchart illustrating an attack feature DNA analysis device according to an embodiment of the present invention.

Referring to FIG. 6, a method for analyzing attack similarity by the attack feature DNA analysis device 200 is illustrated.

In S601, the DNA generating unit 123 classifies the past attack feature DNAs (401, 403, 405, 407) by attacking patterns and stores the result.

In S603, the information processing unit 110 collects the event information.

In S605, the actor extracting unit 121 extracts normal factors 310 and attack feature factors 320 from the event information.

In S607, the DNA generating unit 123 analyzes correlation of the attack feature factor to the normal factor 310 and generates the attack feature DNA 323 which represents the correlation analysis result in a DNA structure.

In S609, the attack similarity analyzing unit 201 compares the attack feature DNA 323 with the past attack feature DNAs (401, 403, 405, 407) classified by attacking patterns to analyze the similarity. The similarity analysis result can be represented by a numerical value and particularly, in percent.

In S611, the DNA visualizing unit 125 visualizes the similarity analysis result which is obtained by comparing the attack feature DNA 323 with the past attack feature DNAs (401, 403, 405, 407) classified by attacking patterns.

In S613, the displaying unit 150 displays the similarity analysis result on the screen.

While it has been described with reference to particular embodiments, it is to be appreciated that various changes and modifications may be made by those skilled in the art without departing from the spirit and scope of the embodiment herein, as defined by the appended claims and their equivalents.

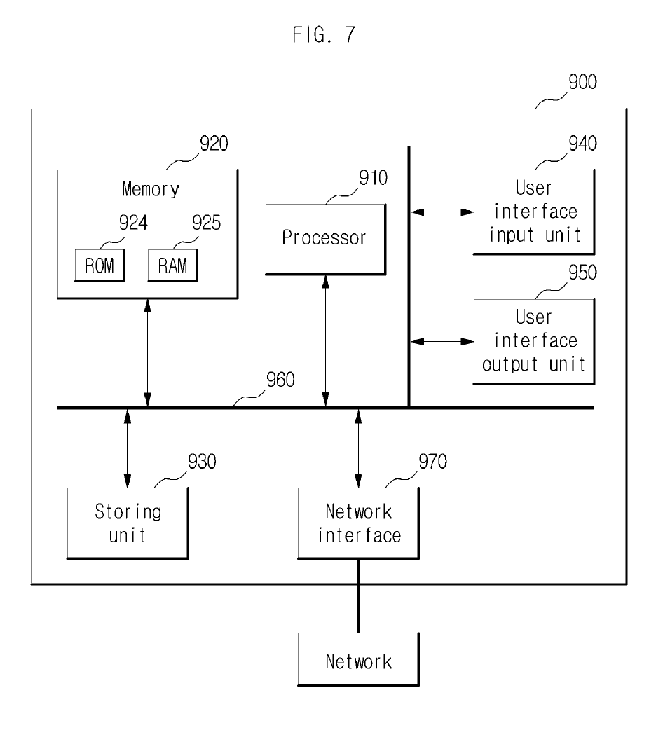

Exemplary embodiments of the present invention may be implemented in a computer system, for example, a computer readable recording medium. As shown in FIG. 7, a computer system 900 may include at least one of at least one processor 910, a memory 920, a storing unit 930, a user interface input unit 940 and a user interface output unit 950. The computer system 900 may further include a network interface 970 to connect to a network. The processor 910 may be a CPU or semiconductor device which executes processing commands stored in the memory 920 and/or the storing unit 930. The memory 920 and the storing unit 930 may include various types of volatile/non-volatile storage media. For example, the memory may include ROM 924 and RAM 925.

Accordingly, exemplary embodiments of the present invention may be implemented by a method implemented with a computer or by a non-volatile computer recording medium in which computer executable commands are stored. The commands may be performed by at least one embodiment of the present invention when they are executed by the processor.

### DESCRIPTION OF REFERENCE NUMERALS

100: Attack feature DNA generator

110: Information processing unit

120: Control unit

121: Factor extracting unit

123: DNA generating unit

125: DNA visualizing unit

130: Storing unit

140: Displaying unit

200: Attack feature DNA analysis device

201: Attack similarity analyzing unit

What is claimed is:

1. An attack feature DNA generator comprising:
an information processing unit collecting event information from a network environment;
a factor extracting unit extracting normal factors and attack feature factors from the event information;
a DNA generating unit analyzing correlation of the attack feature factor to the normal factor and generating an attack feature DNA which shows the correlation analysis result in a DNA structure; and
a storing unit in which the event information and the attack feature DNA are stored.

2. The attack feature DNA generator of claim 1, wherein the network environment is a single network.

3. The attack feature DNA generator of claim 1, wherein the attack feature DNA is classified and stored by attacking patterns in the storing unit.

4. The attack feature DNA generator of any of claim 1, further comprising a DNA visualizing unit visualizing the attack feature DNA.

5. The attack feature DNA generator of claim 4, further comprising a displaying unit displaying the visualized attack feature DNA.

6. The attack feature DNA generator of claim 4, wherein the DNA visualizing unit visualizes the attack feature DNA in a 3D type.

7. An attack feature DNA analysis device comprising;
an information processing unit collecting event information from a network environment;
a factor extracting unit extracting normal factors and attack feature factors from the event information;
a DNA generating unit analyzing correlation of the attack feature factor to the normal factor and generating an attack feature DNA which shows the correlation analysis result in a DNA structure;
a storing unit in which past attack feature DNAs classified by attacking patterns are stored; and
an attack similarity analyzing unit analyzing similarity by comparing the attack feature DNA with the past attack feature DNAs stored in the storing unit.

8. The attack feature DNA analysis device of claim 7, wherein the attack similarity analyzing unit represents similarity between the attack feature DNA and the attack feature DNA classified by attacking patterns in a numerical value.

9. A method for generating attack feature DNA, the method comprising:
collecting event information from a network environment;
extracting normal factors and attack feature factors from the event information;
analyzing correlation of the attack feature factor to the normal factor and generating an attack feature DNA which shows the correlation analysis result in a DNA structure; and
storing the event information and the attack feature DNA.

10. The method of claim 9, wherein the step of storing the event information and the attack feature DNA classifies and stores the attack feature DNA by attacking patterns.

11. The method of claim 9, further comprising visualizing the attack feature DNA.

12. A method for analyzing attack feature DNA, the method comprising:
storing past attack feature DNAs classified by attacking patterns;
collecting event information from a network environment;
extracting normal factors and attack feature factors from the event information;
analyzing correlation of the attack feature factor to the normal factor and generating an attack feature DNA which shows the correlation analysis result in a DNA structure;
analyzing similarity by comparing the attack feature DNA with the past attack feature DNAs classified by attacking patterns and stored in the storing unit.

13. The method of claim 12, further comprising visualizing the result of similarity analysis.
